(19) United States
(12) Patent Application Publication
(10) Pub. No.: US 2007/0244952 A1
(43) Pub. Date: Oct. 18, 2007

(54) SIGNAL ANALYSIS METHODS

(75) Inventor: Hugh Kennedy, Canberra (AU)

Correspondence Address: GREENBLUM & BERNSTEIN, P.L.C., 1950 ROLAND CLARKE PLACE, RESTON, VA, 20191, US

(73) Assignee: RDA PTY LTD, Canberra (AU)

(21) Appl. No.: 11/689,830

(22) Filed: Mar. 22, 2007

(30) Foreign Application Priority Data
Mar. 23, 2006 (AU) 2006901479

(51) Int. Cl. G06F 17/15

(52) U.S. Cl. 708/422

(57) ABSTRACT

The invention relates to a method of comparing two or more series of signal analysis data samples, to produce a measure of their similarity. Corresponding data samples of each series are compared, and measures of the magnitude of the signal and the variation between corresponding data samples are calculated. The magnitude measure may simply be the average power of corresponding data samples. The produced measure of the similarity of the series is a test statistic having Snedecor's F distribution. When compared to typical cross correlation methods, a test statistic of the present invention provides a greater distinction between series displaying a high degree of similarity and series with a low degree of similarity. Accordingly, the present invention has applicability to the detection, classification and angular localisation of signals from acoustic or electromagnetic sources.

### FIELD OF THE INVENTION

The present invention relates to the field of digital signal processing. In particular, the present invention relates to assessing the similarity of two or more series of signal data samples, and applications of the present invention include (although are not necessarily limited to) the detection, classification and localisation of signals.

### BACKGROUND OF THE INVENTION

Sensors can be used to detect signal emissions—for example, acoustic or electromagnetic waves (e.g. radar). However, in a noisy environment, such as may be expected on a battlefield, the established methods of detection via amplitude discrepancies in a relatively steady background of noise have been found to result in a relatively high False Alarm Rate (FAR) as any intruding noise of high enough level will trigger the detector.

Accordingly, Constant False Alarm Rate (CFAR) detectors have been developed which provide a specified (low) FAR. CFAR characteristics may be achieved by many different mechanisms. In addition to the current measurement they typically incorporate an estimate of the environmental state. The ‘environmental’ estimate may be used to set an adaptive threshold, or used to scale the current measurement which is then compared against a constant threshold.

Once a signal is detected, the received waveform is typically classified by cross correlation with a template waveform stored in a library. Each template waveform corresponds to a particular class of signal source—for example, the class of weapon fired.

Furthermore, if multiple sensors are used, the direction of the source can also be determined. This can be accomplished by a process of lag estimation—the time delay or lag between receiving the signal at each sensor is calculated and then used to estimate the angle of arrival of the signal. In the lag estimation process, sensors are typically partitioned into pairs, and lag estimates are calculated for each pair. Series of data samples taken from each sensor are cross correlated at different lags, and the lag with the highest correlation value is selected and used to determine the angle of arrival.

There are a number of known cross correlation techniques which can be used for classification or lag estimation purposes. The standard cross correlation of two signals x₁(n), x₂(n) of N samples, where x₂ is shifted by l samples relative to x₁, can be written as:

$${r}_{12} = \frac{1}{N} {\sum }_{n = 0}^{N - 1} {x}_{1} ( n ) {x}_{2} ( n ) \qquad ( 1 )$$

Standard cross correlation gives a positive figure for positive correlation, but a negative figure for negative correlation; however, the figures mean little in an absolute sense. Accordingly, normalised cross correlation is an improvement on standard cross correlation, giving a value that always lies between −1 and +1. +1 means 100% correlation, whereas −1 means 100% correlation in the opposing sense (e.g. signals in antiphase). The normalised cross correlation of two signals x₁(n), x₂(n) of N samples can be written as:

$${rho}_{12} = \frac{{r}_{12}}{{\frac{1}{N} [ {\sum }_{n = 0}^{N - 1} {x}_{1}^{2} ( n ) {x}_{2}^{2} ( n ) ]}^{1 / 2}} \qquad ( 2 )$$

In preference to standard or normalised cross correlation, the generalized correlation method is also used (see The Generalized Correlation Method for Estimation for Time Delay, Knapp and Carter, August 1976, IEE Transactions on Acoustics, Speech, and Signal Processing, Vol. ASSP-24, No. 4, 320). However, each of these techniques requires a preceding detection step. Furthermore each technique can sometimes result in either misclassification of a signal or an incorrect lag estimation—and accordingly, significant angular errors.

### SUMMARY OF THE INVENTION

In a first aspect of the present invention, there is provided a method of assessing the similarity of two or more series of signal data samples comprising:
forming a test statistic which is inversely proportional to a variation measure, the variation measure indicating the variation between the series,
whereby the value of the test statistic therefore provides a measure of the similarity of the series.

Of course, the formation of the test statistic may only be an intermediate step of the assessment process, and other calculations may be performed in addition to the formation of the test statistic when assessing the similarity of the series.

The test statistic may be proportional to a magnitude measure, the magnitude measure indicating the magnitude of the signal.

Preferably, the method of assessing the similarity of two or more series of signal data samples may further comprise:
calculating, for each data sample, a sample variation measure indicating the variation between corresponding data samples of each series, and
calculating the variation measure from the sample variation measures.

In some embodiments, the variation measure is

$${\sum }_{n = 0}^{N - 1} {\hat{σ}}_{n}^{2} ,$$

where N is the number of samples in each series, and
where \hat{σ}ₙ is the observed standard deviation of the set of the nth samples of each series, at a specific lag.

Further, the test statistic may be proportional to

$$\frac{{\sum }_{n = 0}^{N - 1} {\hat{μ}}_{n}^{2}}{{\sum }_{n = 0}^{N - 1} {\hat{σ}}_{n}^{2}} ,$$

where \hat{μ}ₙ is the observed mean of the nth samples of each series, at a specific lag.

Further, the test statistic may be equal to

$$( M - 1 ) \frac{{\sum }_{n = 0}^{N - 1} {\hat{μ}}_{n}^{2}}{{\sum }_{n = 0}^{N - 1} {\hat{σ}}_{n}^{2}} ,$$

where M is the number of series of data samples.

Like other methods, this test statistic can be used to assess the similarity of two series. However, unlike other methods, the test statistic described above may also be used to assess the similarity of three or more series of data samples.

Preferably, the test statistic has a known distribution, which for the test statistic equal to

$$( M - 1 ) \frac{{\sum }_{n = 0}^{N - 1} {\hat{μ}}_{n}^{2}}{{\sum }_{n = 0}^{N - 1} {\hat{σ}}_{n}^{2}}$$

will be Snedecor's F distribution.

In a second aspect of the present invention, there is provided a test statistic for assessing the similarity of two or more series of signal data samples, wherein the test statistic is inversely proportional to a variation measure, the variation measure indicating the variation between the series.

One application of the method and test statistic of the present invention is in angle of arrival estimation, wherein series of signal data samples are compared at a variety of different lags. At different lags, a data sample in one series will correspond to different data samples in other series, depending on the lag. For three of more series of signal data samples, lag combinations may be selected to correspond to possible angles of arrival.

Accordingly, in a third aspect of the present invention, there is provided a method of aligning two or more series of signal data samples comprising:
calculating a test statistic at a first lag combination, wherein the test statistic is inversely proportional to a variation measure, the variation measure indicating the variation between the series;
calculating the test statistic at one or more second lag combinations; and
selecting the lag combination for which the test statistic is greatest, thereby aligning the series.

As will be understood, where there are only two series to be aligned, each lag combination will consist of only one lag.

Of course, there are other applications for the present invention. Classification of a signal of interest is one other obvious example of where it may be desirable to compare two series of signal data samples (for instance, comparing a signal of interest to a template representing a particular class of signal). However, another problem to which the present invention may be applied is the detection of a signal of interest, which conventionally does not assess the similarity between different series of signal data samples.

Accordingly, in a fourth aspect of the present invention, there is provided a method of detecting a signal of interest (SOI) by:
obtaining a first series of signal data samples from a first sensor;
obtaining a second series of signal data samples from a second sensor;
calculating, from the first and second series, a test statistic which provides a measure of the similarity between the first and second series at a first lag of zero or more data samples;
calculating the test statistic at one or more second lags of zero or more data samples; and
declaring a detection if the largest calculated test statistic is more extreme than a threshold value.

Where the test statistic has a known distribution, this means that the threshold value can be set to provide a desired CFAR.

In further aspects, the present invention provides computer readable media encoded with data representing computer programs, that can be used to direct a programmable device to perform the above methods.

In yet further aspects of the present invention, computer program elements are provided comprising computer program code means to make a programmable device execute the above methods.

In yet further aspects of the present invention, there are provided computer processing devices configured to perform the above methods.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the scope of the invention encompasses numerous alternatives, modifications and equivalents. For the purpose of example, specific details are set forth in the following description in order to provide a thorough understanding of the present invention.

For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 depicts an incoming signal to be received by a linear array of sensors;

FIG. 2 is a flow diagram of one embodiment of the present invention;

FIG. 3 is a plot of two series of signal data samples for a signal of interest, aligned at the most likely lag;

FIG. 3A is a plot of test statistics calculated for the data in FIG. 2, plotted as a function of lag for four candidate lag-estimation methods;

FIGS. 4, 5, 6, 7, 8 and 9 are each a plot of two series of signal data samples for different signals of interest, aligned at the most likely lag; and

FIGS. 4A, 5A, 6A, 7A, 8A and 9A are each a plot of test statistics calculated for the data in FIGS. 4, 5, 6, 7, 8 and 9 respectively, plotted as a function of lag for four candidate lag-estimation methods.

### DETAILED DESCRIPTION

This embodiment of the present invention is best described in relation to the problem of angular localisation, although the present invention does have broader application to other circumstances where it is desirable to assess the similarity of two or more series of signal data samples.

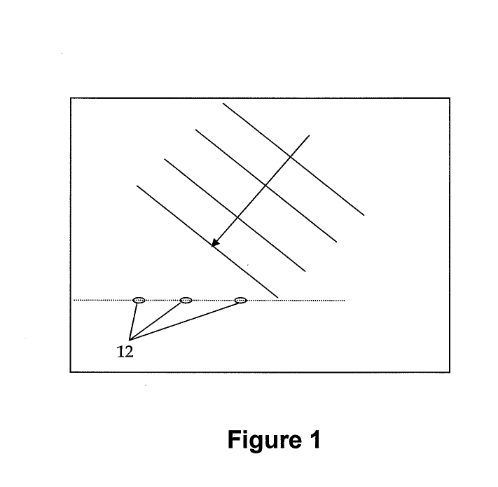

With an array of sensors, a signal of interest (SOI) arriving at an angle as shown in FIG. 1 will be received by each sensor 12 at a different time. In FIG. 1, the right-most sensor receives the SOI first, the middle sensor receives the SOI after a time delay, and the left-most sensor only receives the SOI after another time delay. The angle of arrival (AOA) of the SOI can be determined by the duration of these time delays. For a three dimensional array (at least four sensors arranged in a non-coplanar configuration) the determined AOA can be uniquely determined in three dimensional space.

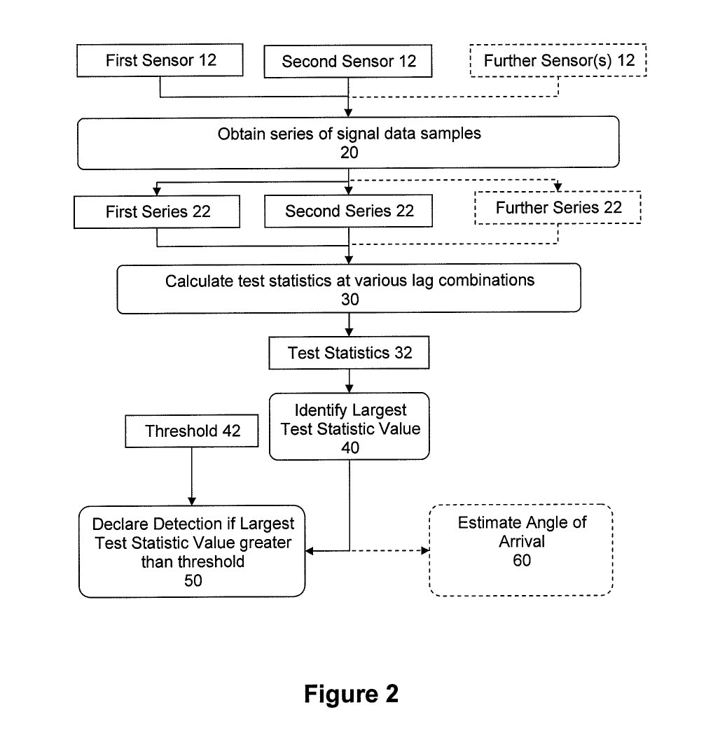

As depicted in FIG. 2, series 22 of signal data samples can be obtained 20 from each sensor 12, and may be measured in volts. To obtain 20 the series 22, a continuous data segment can be extracted from the digitised data samples taken by each sensor 12, for a given analysis window. The data within this analysis window will provide a series 22 of signal data samples, which can be used in the detection, classification or localisation of a signal of interest.

According to the present invention, a statistical treatment of the series of data samples is performed with the null hypothesis being that there is no SOI and that the series contain only zero-mean Gaussian distributed noise. It is herein assumed that any DC offset in the data (e.g. sensor or DAQ bias) or frequencies that are of no interest (e.g. wind or self noise) have been removed by a pre-whitening stage. The test statistic for all possible lag combinations corresponding to all physically measurable angles is calculated 30, and the largest calculated test statistic 32 is identified 40. If the largest calculated test statistic is greater than a threshold value 42 (preferably set to give a specified CFAR) then the null hypothesis is rejected, and a detection is declared 50. Furthermore, in this way the series 22 can be aligned, and the most likely direction of the source can be set equal to the angular coordinate for which the null hypothesis is least likely, i.e. the angle of arrival is estimated 60 by selecting the angle which corresponds to the lag combination for which the test statistic is maximised.

The test statistic is a measure of similarity, applied to two or more series of signal data samples. In this embodiment, the signals are delayed acoustic sensor signals.

The delay-and-sum (beam-formed) total of the two or more series is applied as:

$$y ( n ) = {\sum }_{m = 0}^{M - 1} {x}_{m} ( n ) \qquad ( 3 )$$

where xₘ(n) is the nth sample of the mth sensor at a specified lag of data samples, and y(n) is the delay-and-sum total. It is assumed that the data in the channel xₘ has already been delayed to steer the beam in the desired direction.

The noise statistics of each sensor are assumed to be the same, so the nth sample in each delay channel is assumed to be an independent observation of the random variable Xₙ, giving a total of N different random variables, with M observations for each variable. Under the null hypothesis the variables have a Gaussian (or normal) distribution:

Xₙ˜N(μₙ,σₙ²) (4)

The Maximum Likelihood Estimates (MLE) \hat{μ}ₙ and \hat{σ}ₙ, of the mean and variance are computed using:

$$\begin{matrix}{\hat{μ}}_{n} = \frac{y ( n )}{M} and & ( 5 ) \\ {\hat{σ}}_{n}^{2} = \frac{1}{M} \{ {\sum }_{m = 0}^{M - 1} {{x}_{m} ( n )}^{2} - \frac{{y ( n )}^{2}}{M} \} & ( 6 )\end{matrix}$$

Under the null hypothesis, the following relationships hold:

$$\begin{matrix}a . If {Z}_{a} = M \frac{{( {\hat{μ}}_{n} - {μ}_{n} )}^{2}}{{σ}_{n}^{2}} then {Z}_{a} \sim {χ}^{2} ( 1 ) & ( 7 ) \\ b . If {Z}_{b} = M \frac{{\hat{σ}}_{n}^{2}}{{σ}_{n}^{2}} then {Z}_{b} \sim {χ}^{2} ( M - 1 ) & ( 8 )\end{matrix}$$

That is, the quantities Zₐ and Z_{b} are distributed as χ² (chi-squared) variables with 1 and M−1 degrees of freedom respectively.

Under the null hypothesis it is also assumed that the noise statistics of the sensor outputs are zero mean and time invariant so the parameters of each distribution are the same:

μᵢ=μ₂=, . . . ,=μ_{N}=μ=0 (9)

and

σ₁²=σ₂²=, . . . ,=σ_{N}²=σ² (10)

Using the fact that the sum of χ² variables is a χ² variable, the following aggregate test statistics can be formed and analysed:

$$\begin{matrix} c . If {Z}_{c} = M \frac{{\sum }_{n = 0}^{N - 1} {\hat{μ}}_{n}^{2}}{{σ}^{2}} then {Z}_{c} \sim {χ}^{2} ( N ) & ( 11 ) \\ d . If {Z}_{d} = M \frac{{\sum }_{n = 0}^{N - 1} {\hat{σ}}_{n}^{2}}{{σ}^{2}} then {Z}_{d} \sim {χ}^{2} ( N ( M - 1 ) ) & ( 12 )\end{matrix}$$

So far it has been assumed that the true variance (σ²) of the white noise is known. This is an inconvenient and unnecessary assumption. It can be eliminated by dividing (11) by (12). Furthermore, if the numerator and the denominator are scaled by the inverse of their respective degrees of freedom then a variable distributed according to Snedecors' F distribution results:

$$\begin{matrix}{Z}_{M} = \frac{\frac{{Z}_{c}}{N}}{\frac{{Z}_{d}}{( N ( M - 1 ) )}} & ( 13 ) \\ {Z}_{M} = ( M - 1 ) \frac{{\sum }_{n = 0}^{N - 1} {\hat{μ}}_{n}^{2}}{{\sum }_{n = 0}^{N - 1} {\hat{σ}}_{n}^{2}} & ( 14 ) \\ {Z}_{m} \sim F ( n , n ( m - 1 ) ) & ( 15 )\end{matrix}$$

The Z_{M} value obtained can be used as a test statistic according to this embodiment of the present invention. The term

$${\sum }_{n = 0}^{N} {\hat{σ}}_{n}^{2}$$

accordingly provides a variation measure which indicates the variation between the series.

Substituting the expressions for \hat{μ}ₙ and \hat{σ}ₙ into Eq. (14) yields:

$${Z}_{M } = ( M - 1 ) \frac{\frac{1}{M} {\sum }_{n = 0}^{N - 1} {y ( n )}^{2}}{{\sum }_{m = 0}^{M - 1} {\sum }_{n = 0}^{N - 1} {{x}_{m} ( n )}^{2} - \frac{1}{M} {\sum }_{n = 0}^{N - 1} {y ( n )}^{2}} \qquad ( 16 )$$

Note that Eq. (16) appears to contain sum-of-squares terms that are equivalent to power measurements computed in the time domain. Alternatively, Eq. (16) may be written in terms of moments:

$$\begin{matrix}{Z}_{M} = ( M - 1 ) \frac{{\sum }_{n = 0}^{N - 1} {E [ x ( n ) ]}^{2}}{{\sum }_{n = 0}^{N - 1} E [ {x ( n )}^{2} ] - {\sum }_{n = 0}^{N - 1} {E [ x ( n ) ]}^{2}} using & ( 17 ) \\ E [ x ( n ) ] = \frac{1}{M} {\sum }_{m = 0}^{M - 1} {x}_{m} ( n ) & ( 18 ) \\ E [ {x ( n )}^{2} ] = \frac{1}{M} {\sum }_{m = 0}^{M - 1} {{x}_{m} ( n )}^{2} and & ( 19 ) \\ y ( n ) = {\sum }_{m = 0}^{M - 1} {x}_{m} ( n ) & ( 20 )\end{matrix}$$

When determining the AOA of a SOI, the Z_{M} test statistic can be computed efficiently using sliding windows, implemented in software as circular buffers, to estimate the moments using the delay line inputs xₘ(n).

Furthermore, the final test statistic is the ratio of two squared quantities. If the square of the estimated mean is regarded as the signal power, and the variance the noise power, then Z_{M} may be converted into a signal to noise ratio (SNR) in dB using:

SNR=10 log₁₀(Z_{M}) (21)

Knowing that under the null hypothesis the Z_{M} test statistic is F distributed, allows a detection threshold 42 to be computed to give the desired probability of falsely rejecting the null hypothesis when it is indeed true (a false alarm). If the computed Z_{M} value exceeds the threshold then a localisable signal is instead assumed to be present.

In practice the null hypothesis is rarely entirely true, and false alarms due to nuisance detections are common. Accordingly, a larger detection threshold 42 is usually appropriate, giving a negligible theoretical false alarm probability and an acceptable practical false alarm probability and probability of detection.

The null hypothesis is rejected when the estimated means at each point (\hat{μ}ₙ) are a long way from zero and when the dispersion around the mean is small (as indicated by a small \hat{σ}ₙ). When the null hypothesis is indeed false, applying the appropriate lags results in large \hat{μ}ₙ values and small \hat{σ}ₙ s values because the waveforms in each delay channel are nearly identical (except for disturbances caused by additive white noise).

In the presence of non-localisable signals (e.g. wind noise), or when the incorrect delays are applied, the \hat{μ}ₙ values are large but so are the \hat{σ}ₙ values, which ensures that Z_{M} remains small. It is this characteristic that makes this method an effective detector and localiser, with prominent peaks marking the directions to true sources set against a relatively flat and featureless background.

The Z_{M} test statistic may be used, for example, for beam formation from multiple sensors. The test statistic may be formed for all angles, and the most likely lag used to declare a detection of a SOI and to calculate its AOA. It may be used on pairs of series of signal data samples obtained from respective sensor pairs, or alternatively it could be used on multiple sensors at once.

With most planar or three dimensional sensor arrays, and with the limits of current processing technology, it is too computationally expensive, using software implementations, to continuously form beams in bearing and elevation, to cover the surveillance surface (hundreds of beams must be formed to give the desired angular resolution). Accordingly, a predetection stage may be performed such that the Z_{M} test statistics are only formed when processing data likely to contain a signal of interest. The predetector may, for example, look for a large and/or sudden increase in received signal power. The predetector could then select data segments of potential interest for further processing by a method according to the present invention.

An alternative embodiment encompassed within the scope of the present invention will now be described, wherein a test statistic (in this case Z₁₂) is again inversely proportional to a measure of the variation between the series. Z₁₂ is a measure of similarity, between (exactly) two signals. This method will be described with reference to classification of signals, although it can also be applied to the problem of angular localisation by lag estimation. Similarly, methods utilising the Z_{M} test statistic may be applied to the problem of classification.

For the Z₁₂ test statistic, it is assumed that the features being classified are impulsive or transient, i.e. they have a finite duration, typically with a rapid onset and a more gradual decay. A template is used to represent a given class, for example the type of weapon fired. Separate templates may, for example, be used for the ‘crack’ (the supersonic shockwave emitted by the passing bullet) and ‘thump’ (the muzzle blast) of a particular weapon.

A sensor is used to obtain a series of signal data samples of a waveform for a signal of interest, which is then compared against the template. The comparison is done using a least-squares fit. Large fitting coefficients suggest that the received waveform may belong to the class represented by the template. Optionally, the significance of the fitting coefficient is assessed using the residual of the fit. The comparison may be done by identifying the start of the feature in the waveform being classified, or if this cannot be done reliably then the fit may be implemented for all possible displacements using a matched filter.

This process may be formalised as follows. Let the template be the series x₁(n), and the waveform containing the feature to be classified x₂(n). It is assumed that the onset of the signature in the template and the waveform is at n=0 and that both x₁(n) and x₂(n) are of equal length. The null hypothesis is that there is no correlation between the two series. The signature in the waveform has been corrupted by additive white noise. The model is:

x₂(n)=β₁₂x₁(n)+ε (22)

We are assuming that the template is a perfect representation of the class, i.e. that it does not contain noise. This representation may be constructed from a theoretical model, from filtered or enhanced measurements, or simply set equal to raw measurements, which are assumed to be noise free. The most appropriate method depends on how well the signature can be measured and how well the feature can be modelled. It is also assumed here that the onset point of the signature in x₁(n), can be identified, as misalignment will cause errors. When misalignment is unavoidable, the calculation described below may be repeated over a range of displacements, with the value of the best displacement used for decision-making purposes.

The MLE estimate of β₁₂ is computed using:

$$\begin{matrix}{\hat{β}}_{12} = \frac{{\sum }_{n = 0}^{N - 1} {x}_{1} ( n ) {x}_{2} ( n )}{{\sum }_{n = 0}^{N - 1} {x}_{1} ( n ) {x}_{1} ( n )} or & ( 23 ) \\ {\hat{β}}_{12} = {( {x}^{′} \cdot x )}^{- 1} {x}^{′} \cdot y & ( 24 )\end{matrix}$$

where x=x₁(n) and y=x₂(n)

If the template has been pre-normalised before it is used, so that x′·x=1, then:

$$\begin{matrix}{\hat{β}}_{12} = {\sum }_{n = 0}^{N - 1} {x}_{1} ( n ) {x}_{2} ( n ) or & ( 25 ) \\ {\hat{β}}_{12} = {x}^{′} \cdot y and & ( 26 ) \\ {\tilde{σ}}_{12} = \sqrt{\frac{1}{N - 1} {( y - x {\hat{β}}_{12} )}^{′} ( y - x {\hat{β}}_{12} )} & ( 27 )\end{matrix}$$

The following test statistic can be formed:

$$\begin{matrix}{Z}_{12} = \frac{{\hat{β}}_{12} - {β}_{12}}{\sqrt{{\tilde{σ}}_{12}^{2}}} with & ( 28 ) \\ {Z}_{12} \sim t ( N - 1 ) & ( 29 )\end{matrix}$$

That is, Z₁₂ is distributed as a Student's t variable. It is also inversely proportional to the variation measure \sqrt{\hat{σ}₁₂²} which provides a measure of the variation between the series.

Classification can therefore be conducted by calculating the Z₁₂ test statistic for each template, and selecting the template with the best fit.

Alternatively, Z₁₂ can be used for detection/localisation purposes wherein the null hypothesis is that the data contains only noise. A confidence level or false alarm rate can be set according to the magnitude of the Z₁₂ test statistic.

When processing impulsive transients due to gunshots, that the duration (the time interval containing approximately 90% of the signals energy) of a ‘crack’ is approximately 0.001 seconds, or 20 samples at 20,000 samples per second. The duration of a ‘thump’ is approximately 0.01 seconds, or 200 samples. Ideally, the entire feature should be used for lag estimation and for classification. However, it has been found that coherence decreases, and variability increases, as the time after the initial wavefront onset time increases, primarily due to multi-path propagation and reverberation. It has also been found that it is useful to include sections of ‘quiet’ data in the series analysed, both before and after the feature of interest. The series analysed may therefore include an additional 25%-50% of the duration of the feature in quiet data before the feature, and an additional 50%-75% after the feature.

### EXAMPLES

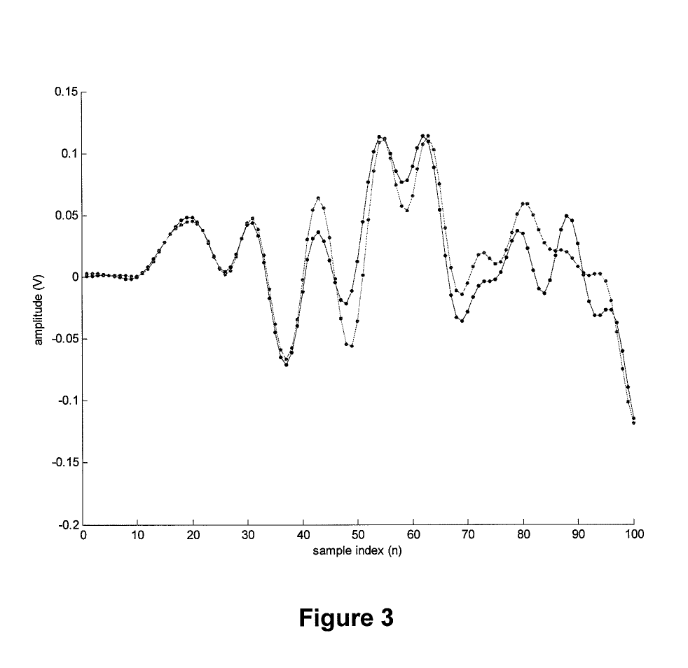

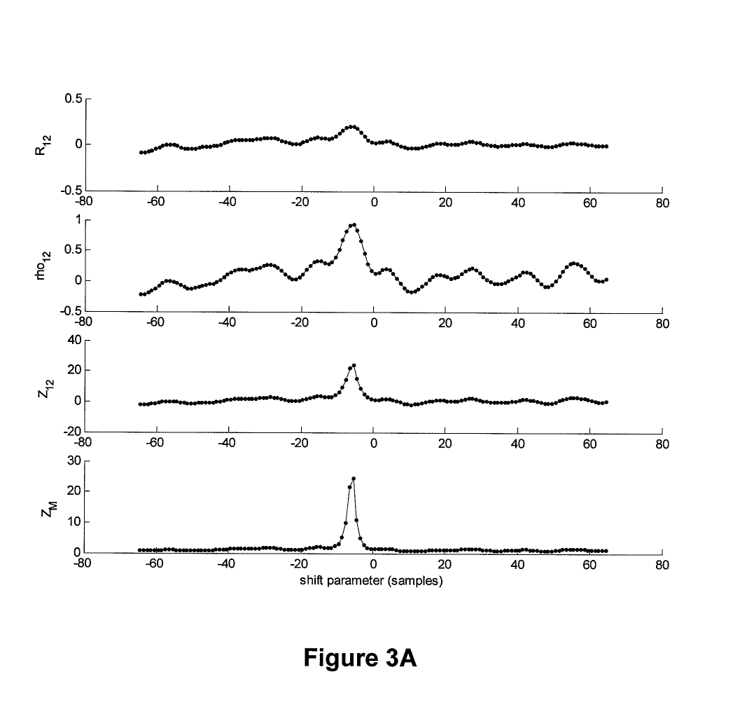

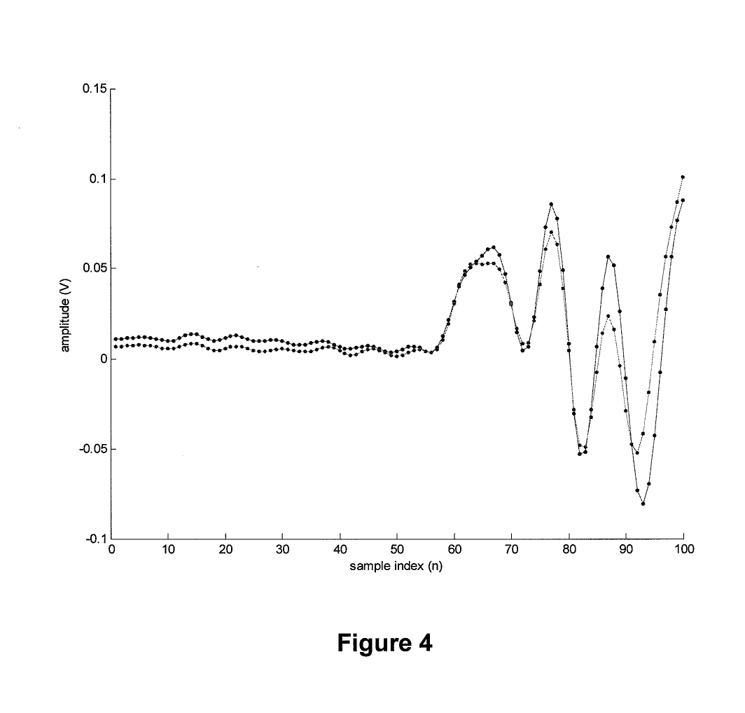

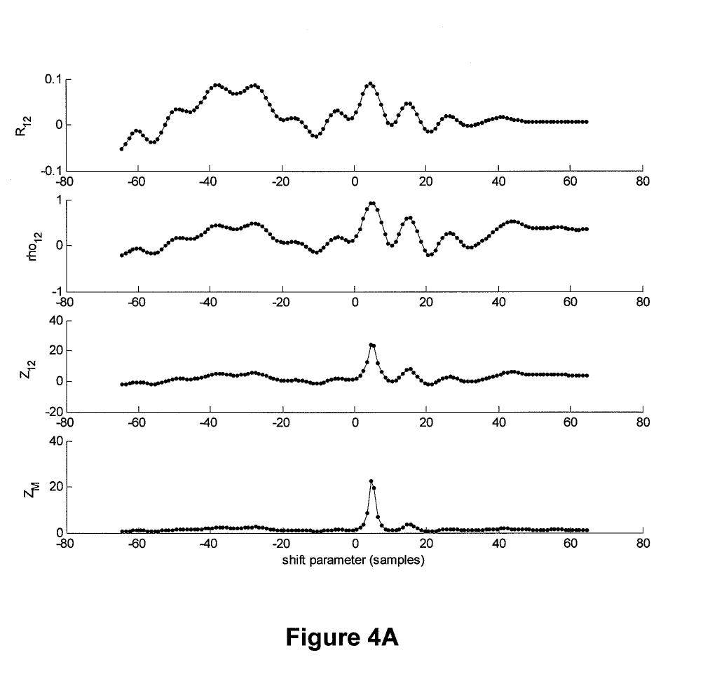

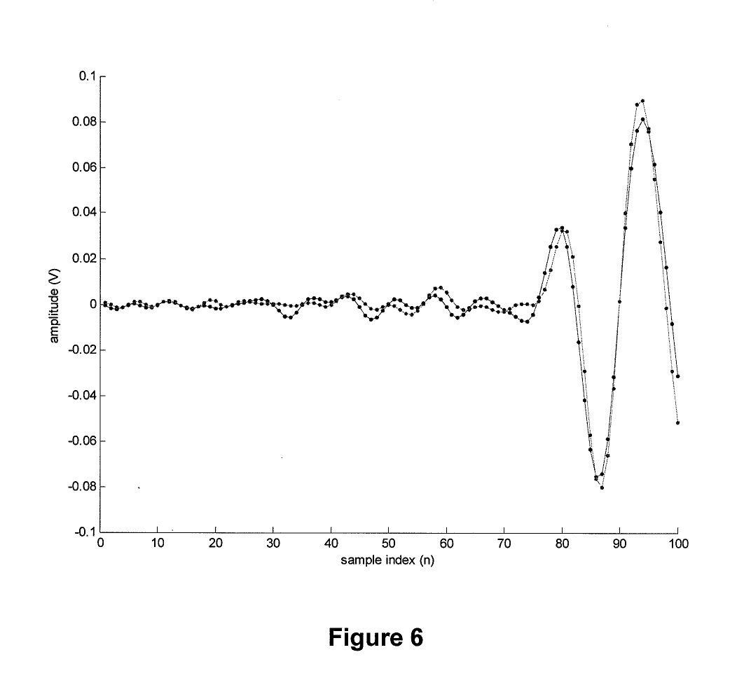

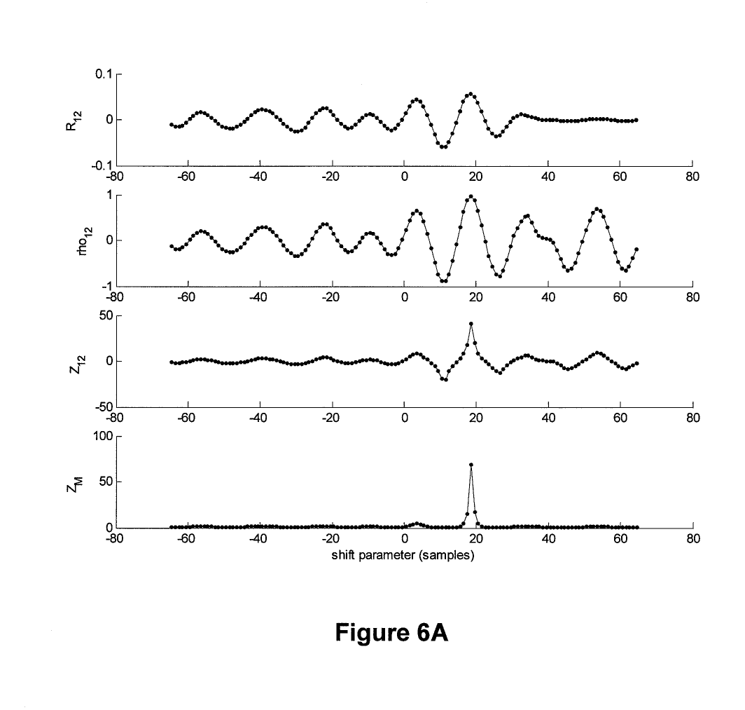

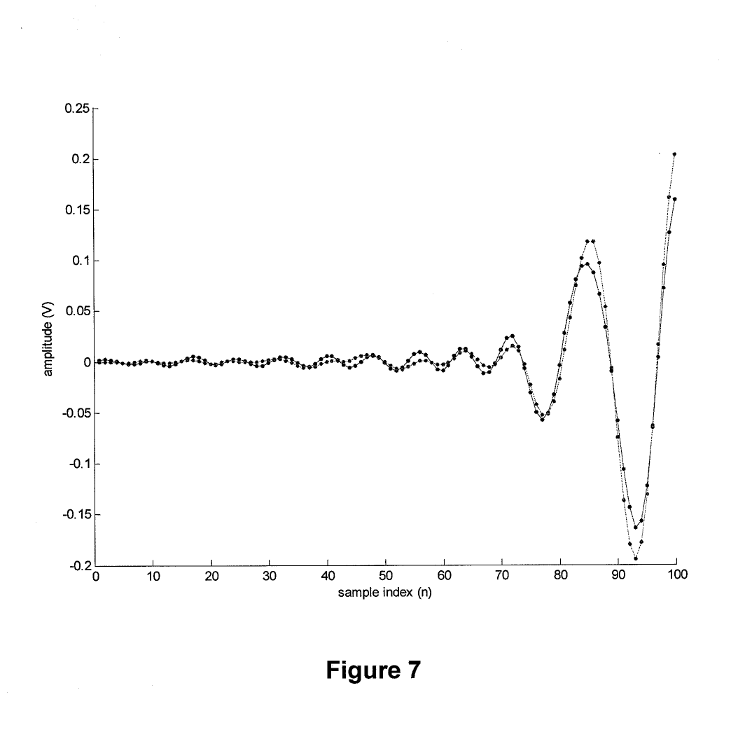

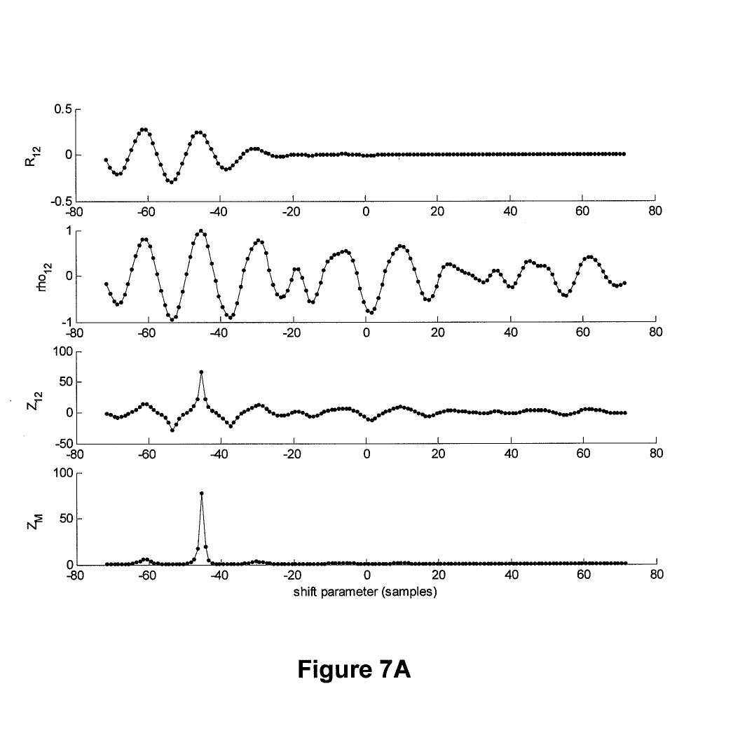

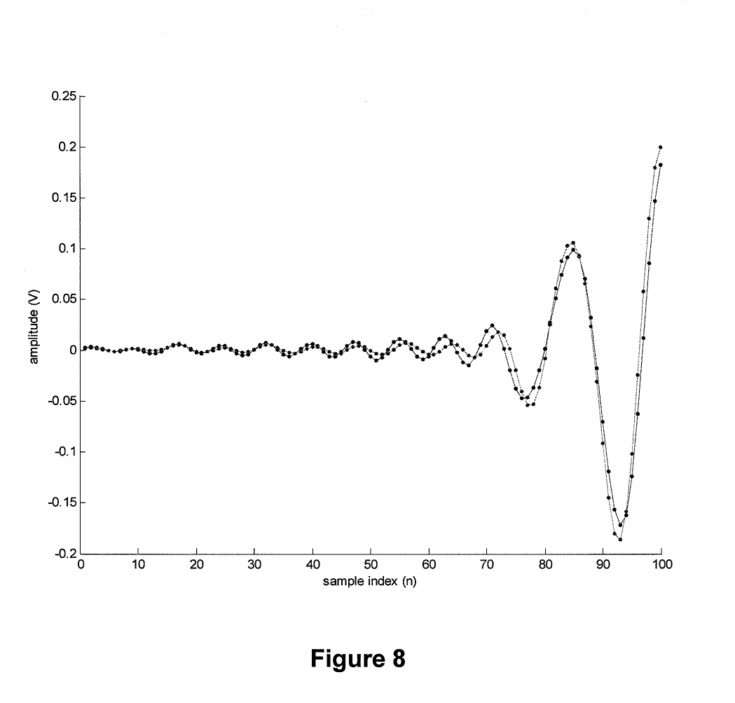

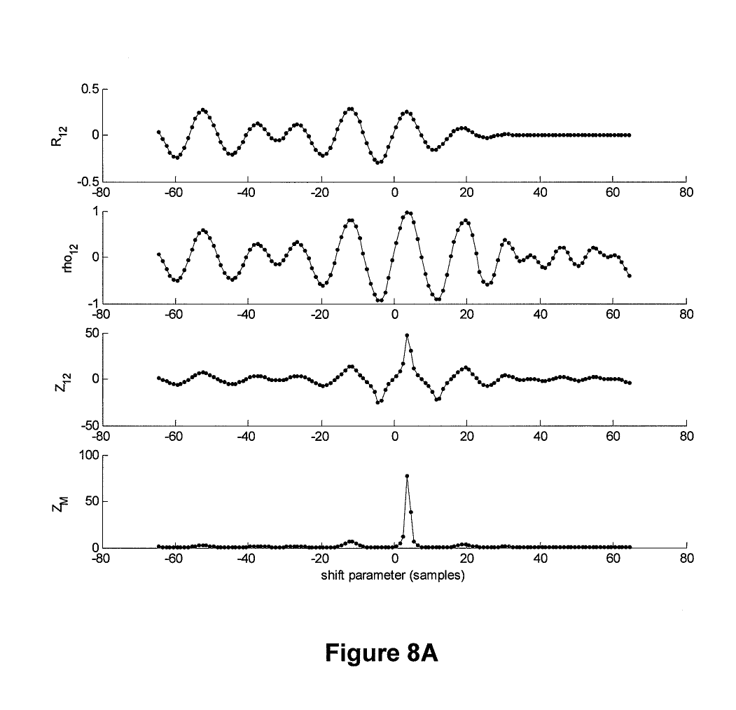

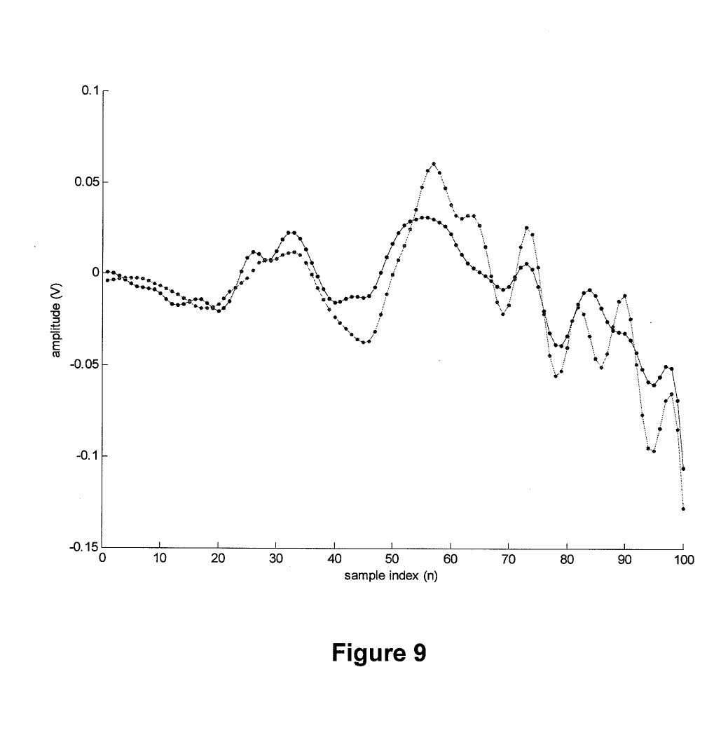

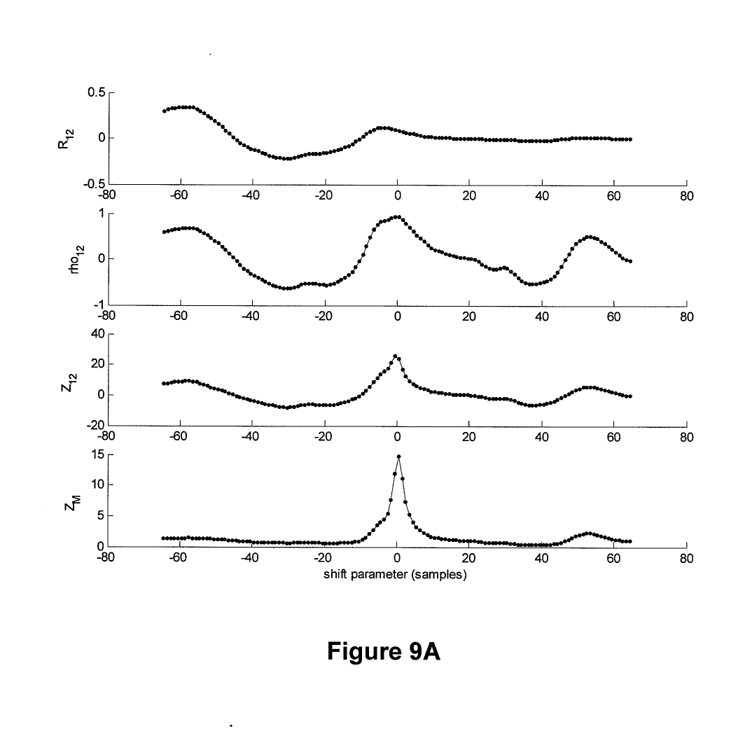

By way of example, with respect to lag estimation and angular localisation, FIG. 2 depicts a plot of two series of acoustic signal data samples for a signal of interest, obtained from two respective acoustic sensors. The data have been aligned as for the most likely lag—that is, the lag for which the test statistics according to the present invention are maximised. FIGS. 3, 4, 5, 6, 7, and 8 simply represent data series obtained for different signals of interest.

FIG. 2A is a plot of test statistics computed using four candidate lag estimation methods plotted as a function of the lag (or time-shift parameter), for the series shown in FIG. 2. FIGS. 3A, 4A, 5A, 6A, 7A and 8A correspond to the series shown in the other respective figures. The four candidate methods are standard cross correlation (r₁₂/R₁₂), normalised cross correlation (rho₁₂), Z_{M} test statistics according to the present invention, and Z₁₂ test statistics according to the present invention. As can be seen from the figures, the test statistics according to the present invention provide much sharper and more prominent peak at the most likely lag, with the Z_{M} test statistic providing the sharpest peaks of all.

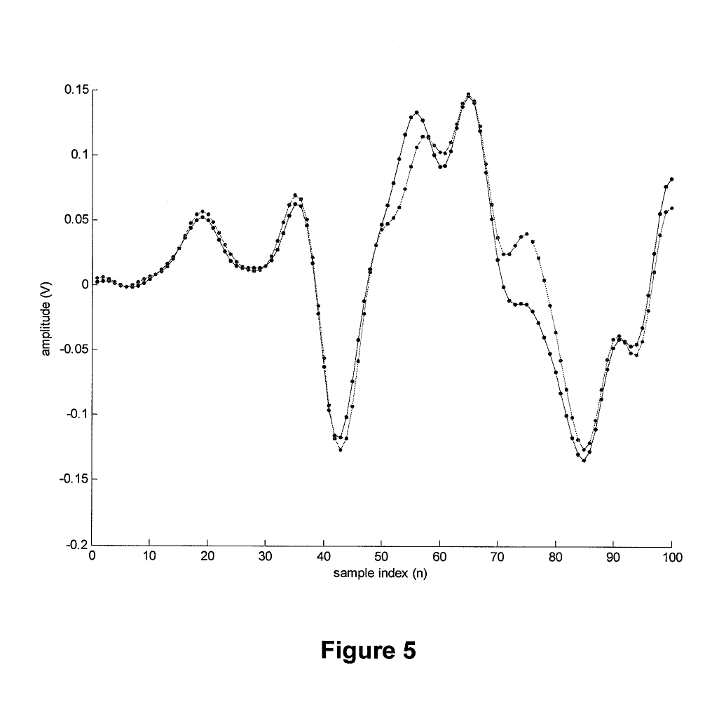

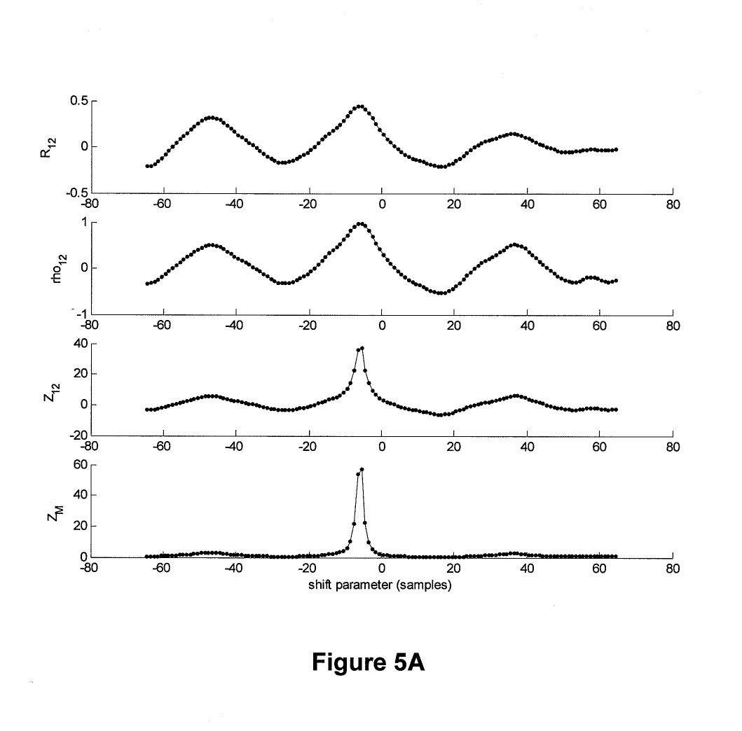

In FIGS. 2A, 3A and 4A, this makes little quantitative difference to the final selection of the best lag estimate. However, for FIGS. 5A, 6A, 7A and 8A, the highest peak for the r₁₂ method is at the incorrect lag. This results in large angular errors being calculated for the incoming signal of interest.

In addition to improved accuracy in the estimation of the lag between series, the Z_{M} and Z₁₂ variables have a known distribution, which allows a confidence level to be placed on the lag estimate. Poor lag estimates, for which the calculated test statistics are beneath a threshold value, can therefore be considered unreliable, and ignored. This improves accuracy by eliminating bad localisation results (or allowing for unknown classes).

Whilst both methods according to the present invention give a greater ‘dynamic range’ than normalised cross correlation (giving greater difference between good and bad lag estimates), the Z_{M} method requires far less computational power than the Z₁₂ method. It can be calculated efficiently using sliding windows and, relative to normalised cross correlation, the Z_{M} method requires only a few more floating point operations per sample pair. On the other hand, the Z₁₂ method requires two loops through the data vector—the first to determine the MLE fitting coefficient, and the second to determine the variation measure.

Yet another advantage of the Z_{M} method is that it can be extended to give the similarity of any number of series of signal data samples, whilst the other methods are only useful for two series at a time.

Although an embodiment of the present invention has been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention. For example, although particular reference has been made to acoustic signal analysis, the present invention has more broad application in the analysis of other types of signal, e.g. radar. Furthermore, although the Z_{M} and Z₁₂ methods were described in relation to localisation and classification respectively, both could be used for either application or for any situation where it is desirable to assess the similarity of series of signal data samples—i.e. the present invention may replace operations that require cross correlation, matched filtering or template matching giving greater expected performance (higher probability of detection and lower false alarm rate). Such operations are typically performed in radar and (active) sonar range processing, feature detection in images, classification of signals and passive direction finding of (intercepted) communication signals.

It should be also appreciated that the present invention can be implemented in numerous ways, including as a process, an apparatus, a system, or a computer readable medium such as a computer readable storage medium or a computer network wherein program instructions are sent over optical or electronic communication links. Furthermore, the methods of the present invention could be implemented in hardware (as a computer processing device), on dedicated co-processing chips, possibly using Field Programmable Gate Arrays (FPGAs). This may enable real-time beam formation with 3-dimensional sensor arrays. It should be noted that the order of the steps of disclosed processes may be altered within the scope of the invention.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

1. A method of assessing the similarity of two or more series of signal data samples comprising:
forming a test statistic which is inversely proportional to a variation measure, the variation measure indicating the variation between the series,
whereby the value of the test statistic therefore provides a measure of the similarity of the series.

2. A method according to claim 1, wherein the test statistic is proportional to a magnitude measure, the magnitude measure indicating the magnitude of the signal.

3. A method according to claim 1, further comprising:
calculating, for each data sample, a sample variation measure indicating the variation between corresponding data samples of each series, and
calculating the variation measure from the sample variation measures.

4. A method according to claim 1, wherein the variation measure is
$${\sum }_{n = 0}^{N - 1} {\hat{σ}}_{n}^{2} ,$$
where N is the number of samples in each series, and
where \hat{σ}ₙ is the observed standard deviation of the set of the nth samples of each series, at a specific lag.

5. A method according to claim 4, wherein the test statistic is proportional to
$$\frac{{\sum }_{n = 0}^{N - 1} {\hat{μ}}_{n}^{2}}{{\sum }_{n = 0}^{N - 1} {\hat{σ}}_{n}^{2}} ,$$
where \hat{μ}ₙ is the observed mean of the nth samples of each series, at a specific lag.

6. A method according to claim 5, wherein the test statistic is equal to
$$( M - 1 ) \frac{{\sum }_{n = 0}^{N - 1} {\hat{μ}}_{n}^{2}}{{\sum }_{n = 0}^{N - 1} {\hat{σ}}_{n}^{2}} ,$$
where M is the number of series of data samples.

7. A method according to claim 1, wherein the number of series of data samples is more than two.

8. A method according to claim 1, wherein the test statistic has a known distribution.

9. A method according to claim 8, wherein the known distribution is Snedecor's F distribution.

10. A method according to claim 1, further comprising:
obtaining at least one of the series of signal data samples from a sensor.

11. A test statistic for assessing the similarity of two or more series of signal data samples, wherein the test statistic is inversely proportional to a variation measure, the variation measure indicating the variation between the series.

12. A test statistic according to claim 1, wherein the test statistic is proportional to a magnitude measure, the magnitude measure indicating the magnitude of the signal.

13. A test statistic according to claim 11, wherein the variation measure is
$${\sum }_{n = 0}^{N - 1} {\hat{σ}}_{n}^{2} ,$$
where N is the number of samples in each series, and
where \hat{σ}ₙ is the observed standard deviation of the set of the nth samples of each series, at a specific lag.

14. A test statistic according to claim 13, wherein the test statistic is proportional to
$$\frac{{\sum }_{n = 0}^{N - 1} {\hat{μ}}_{n}^{2}}{{\sum }_{n = 0}^{N - 1} {\hat{σ}}_{n}^{2}} ,$$
where \hat{μ}ₙ is the observed mean of the nth samples of each series, at a specific lag.

15. A method according to claim 14, wherein the test statistic is equal to
$$( M - 1 ) \frac{{\sum }_{n = 0}^{N - 1} {\hat{μ}}_{n}^{2}}{{\sum }_{n = 0}^{N - 1} {\hat{σ}}_{n}^{2}} ,$$
where M is the number of series of data samples.

16. A method of aligning two or more series of signal data samples comprising:
calculating a test statistic at a first lag combination, wherein the test statistic is inversely proportional to a variation measure, the variation measure indicating the variation between the series;
calculating the test statistic at one or more second lag combinations; and
selecting the lag combination for which the test statistic is greatest, thereby aligning the series.

17. A method according to claim 16, wherein there are three or more series of signal data samples.

18. A method according to claim 17, wherein each series is obtained from a different sensor, and the method is used for determining the angle of arrival of a signal relative to the three or more sensors, and wherein each lag combination corresponds to a possible angle of arrival of the signal.

19. A method according to claim 16, wherein the test statistic is proportional to a magnitude measure, the magnitude measure indicating the magnitude of the signal.

20. A method according to claim 16, wherein the calculation of the test statistic comprises:
calculating, for each data sample, a sample variation measure indicating the variation between corresponding data samples of each series, and
forming the variation measure from the sample variation measures.

21. A method according to claim 20, wherein the test statistic is proportional to
$$\frac{{\sum }_{n = 0}^{N - 1} {\hat{μ}}_{n}^{2}}{{\sum }_{n = 0}^{N - 1} {\hat{σ}}_{n}^{2}} ,$$
where \hat{μ}ₙ is the observed mean of the nth samples of each series, at a specific lag.

22. A method according to claim 21, wherein the test statistic is equal to
$$( M - 1 ) \frac{{\sum }_{n = 0}^{N - 1} {\hat{μ}}_{n}^{2}}{{\sum }_{n = 0}^{N - 1} {\hat{σ}}_{n}^{2}} ,$$
where M is the number of series of data samples.

23. A method of detecting a signal of interest by:
obtaining a first series of signal data samples from a first sensor;
obtaining a second series of signal data samples from a second sensor;
calculating, from the first and second series, a test statistic which provides a measure of the similarity between the first and second series at a first lag of zero or more data samples;
calculating the test statistic at one or more further lags of zero or more data samples; and
declaring a detection if the largest calculated test statistic is more extreme than a threshold value.

24. A method according to claim 23, wherein the test statistic is inversely proportional to a variation measure, the variation measure indicating the variation between the series.

25. A method according to claim 23, wherein the test statistic is proportional to a magnitude measure, the magnitude measure indicating the magnitude of the signal.

26. A method according to claim 23, wherein the variation measure is
$${\sum }_{n = 0}^{N - 1} {\hat{σ}}_{n}^{2} ,$$
where N is the number of samples in each series, and
where \hat{σ}ₙ is the observed standard deviation of the set of the nth samples of each series, at a specific lag.

27. A method according to claim 26, wherein the test statistic is proportional to
$$\frac{{\sum }_{n = 0}^{N - 1} {\hat{μ}}_{n}^{2}}{{\sum }_{n = 0}^{N - 1} {\hat{σ}}_{n}^{2}} ,$$
where \hat{μ}ₙ is the observed mean of the nth samples of each series, at a specific lag.

28. A method according to claim 27, wherein the test statistic is equal to
$$( M - 1 ) \frac{{\sum }_{n = 0}^{N - 1} {\hat{μ}}_{n}^{2}}{{\sum }_{n = 0}^{N - 1} {\hat{σ}}_{n}^{2}} ,$$
where M is the number of series of data samples.

29. A method according to claim 23, further comprising:
obtaining at least one further series of signal data samples from at least one further sensor,
wherein the test statistic provides a measure of the similarity between the first, second and further series, and the test statistic is calculated at a first combination of lags of zero or more data samples, and at one or more further combinations of lags of zero or more data samples, and
and wherein each combination of lags relates to an angle of arrival for the signal relative to the first, second and further sensors.

30. A method according to claim 29, wherein the angle of arrival of the signal of interest is determined by identifying the combination of lags at which the test statistic is highest.

31. A computer readable medium encoded with data representing computer programs, that can be used to direct a programmable device to perform a method as claimed in claim 1.

32. A computer processing device, configured to perform the method of claim 1.

33. A computer readable medium encoded with data representing computer programs, that can be used to direct a programmable device to perform a method as claimed in claim 16.

34. A computer readable medium encoded with data representing computer programs, that can be used to direct a programmable device to perform a method as claimed in claim 23.

35. A computer processing device, configured to perform the method of claim 16.

36. A computer processing device, configured to perform the method of claim 23.
